(19) United States
(12) Patent Application Publication
(10) Pub. No.: US 2016/0018133 A1
(43) Pub. Date: Jan. 21, 2016

(54) Folded Ground Coupled Heat Exchange System And Method Of Installation

(71) Applicants: Kelvin P. Self, Stillwater, OK (US); Richard F. Sharp, Perry, OK (US)

(72) Inventors: Kelvin P. Self, Stillwater, OK (US); Richard F. Sharp, Perry, OK (US)

(73) Assignee: The Charles Machine Works, Inc., Perry, OK (US)

(21) Appl. No.: 13/569,796

(22) Filed: Aug. 8, 2012

Related U.S. Application Data
(60) Provisional application No. 61/521,628, filed on Aug. 9, 2011.

(51) Int. Cl. F24J 3/08; B23P 15/26; B23P 19/04

(52) U.S. Cl. CPC F24J 3/081; B23P 15/26

(57) ABSTRACT

A ground source heat exchanger for use with a heat pump. The heat exchanger comprises a foldable, expandable outer pipe with an inner pipe that is placed within a borehole. The outer pipe may be folded and sealed at one end while out of the borehole. The outer pipe is inserted into the borehole then expanded by pressure to minimize the annulus between the outer pipe and the ground. The inner pipe is inserted and the inner and outer pipes are connected to the heat pump for circulation of heat exchange fluid.

### CROSS REFERENCE TO RELATED APPLICATION

This application claims the benefit of provisional patent application Ser. No. 61/521,628 filed on Aug. 9, 2011, the entire contents of which are incorporated herein by reference.

### FIELD OF THE INVENTION

The present invention relates generally to an in-ground heat exchanger for use with a ground source heat pump system.

### SUMMARY OF THE INVENTION

The present invention is directed to a method for installation of a ground coupled heat exchange system for use in a ground source heat pump system. The method comprises inserting a folded outer pipe into a borehole and expanding the folded outer pipe within the borehole.

The invention is also directed to a method for installing a ground coupled heat exchange system. The method comprises drilling a borehole, folding a first pipe to form a U-shaped cross-section, inserting the first pipe into the borehole, supplying grout to an annulus between the borehole and the first pipe, applying a pressure to unfold the first pipe, and inserting a second pipe into the first pipe.

The invention is further directed to a method for exchanging heat in a ground-source heat exchange system. The method comprises drilling a borehole into a subsurface, folding a first pipe, inserting the first pipe into the borehole, providing a material in an annulus between the vertical borehole and the first pipe to secure the first pipe, applying a pressure to unfold the first pipe, positioning a second pipe in the first pipe, providing a heat exchange fluid from a heat pump, the heat exchange fluid having a different temperature than a temperature of the subsurface, forcing the heat exchange fluid to flow through the annulus between the first pipe and second pipe, and returning the heat exchange fluid to the heat pump.

The invention is also directed to a ground coupled heat exchange apparatus. The apparatus comprises a foldable outer pipe for placement within a borehole, an inner pipe located within the outer pipe, and a material. The material is positioned in an annulus between the borehole and the outer pipe to secure the outer pipe within the borehole.

The invention is further directed to a method for securing a ground source heat exchanger comprising a foldable pipe within a vertical borehole. The method comprises providing the foldable pipe within the borehole, placing a tremie line proximate the foldable pipe, pumping a material into the vertical borehole through the tremie line, applying a pressure inside the foldable pipe to unfold the foldable pipe such that the material is distributed about the foldable pipe.

Still yet the invention is directed to a ground coupled heat exchanger for placement within a borehole. The exchanger comprises a folded, expandable outer pipe with a reduced effective diameter, an inner pipe capable of being inserted coaxially into an open first end of the outer pipe, and a manifold attachable to the open first end of the outer pipe and the is inner pipe. The outer pipe comprises the open first end and a sealed second end. The outer pipe is capable of having a larger effective diameter.

### BRIEF DESCRIPTION OF THE DRAWINGS

FIG. 1 is a side view of a heat exchange system in accordance with the present invention.

FIG. 2A is a side view of a ground-coupled heat exchanger for use with the heat exchange system of FIG. 1.

FIG. 2B is a top view of a ground-coupled heat exchanger for use with the heat exchange system of FIG. 1.

FIG. 3 is a top cross-section view of a ground coupled heat exchanger having a folded outer pipe.

FIG. 4 is a perspective view of a ground coupled heat exchanger having an outer pipe with a folded cross-section and a tremie line.

FIG. 5 is an alternative embodiment of a ground coupled heat exchanger having an outer pipe with a folded cross-section and a tremie line.

FIG. 6 is a sectional side view of a downhole end of the heat exchanger of FIG. 2.

FIG. 7A is a sectional side view of a ground coupled heat exchanger having an installed inner pipe.

FIG. 7B is a top view of the heat exchanger of FIG. 7A.

FIG. 8 is a cut-away perspective view of a manifold for use with the heat exchanger of FIG. 2.

FIG. 9A is a side view of an apparatus for fusing a downhole end of the outer pipe of the heat exchanger of FIG. 2.

FIG. 9B is a side view of an apparatus for fusing a downhole end of the outer pipe of the heat exchanger of FIG. 2.

FIG. 9C is a front view of the outer pipe of the heat exchanger of FIG. 2 with corners removed.

FIG. 10 is a perspective view of an apparatus for folding the outer pipe of the heat exchanger of FIG. 2.

FIG. 11 is a flow chart depicting a method for heat exchange in a ground coupled heat exchanger.

### DESCRIPTION OF THE PREFERRED EMBODIMENT

A ground source heat pump is a specific type of central heating and cooling system for homes and other buildings. Ground source systems have been shown to be highly efficient for heating and cooling, especially in a totally electric situation. These systems produce this efficiency by taking advantage of the nearly constant temperature within the ground, using the ground mass and temperature as a heat source in winter and heat sink in summer. Heat energy is exchanged with the ground via a ground coupled heat exchanger installed in the ground. Heat is carried into or from the ground by circulating a heat exchange fluid through pipes which are designed to conduct the energy to or from the pipes to the surrounding ground.

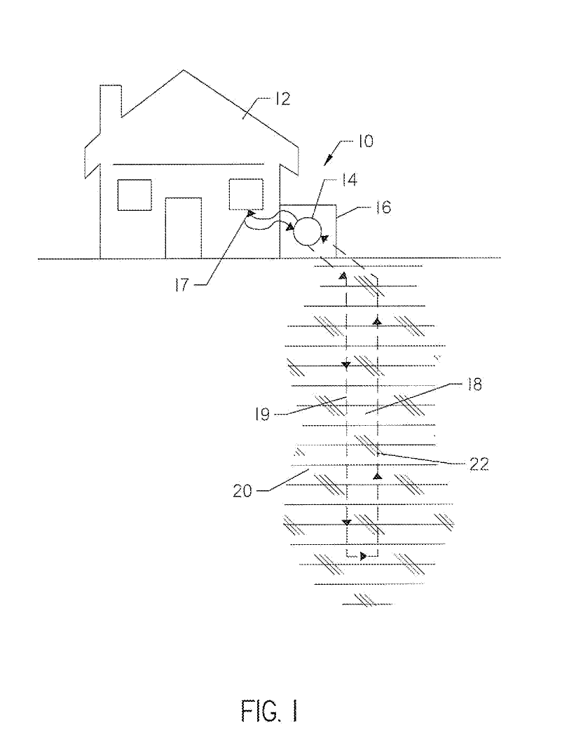

Turning now to the figures in general and FIG. 1 in particular, shown therein is a basic outline of a folded ground-coupled heat exchange system 10. The heat exchange system 10 comprises a structure 12, an air to fluid exchanger 14, a heat pump 16, and a ground coupled heat exchanger 18. A heat exchange fluid 19 travels within the system through the heat pump 16 and the ground coupled heat exchanger 18. The air to fluid heat exchanger 14 is contained within heat pump 16 and is used to exchange heat between the structure 12 and the heat exchange fluid 19. The structure 12 may comprise a residence, commercial structure, or other building in need of heating or cooling. Those skilled in the art should note that the heat pump 16 may comprise a commercially available HVAC ground source heat pump unit. The heat pump 16 directs air 17 from the structure 12 and directs heat exchange fluid 19 from the ground coupled heat exchanger 18 to the air to fluid heat exchanger 14. Air 17 is then heated or cooled within the air to fluid heat exchanger 14 and returned to the structure 12. In a heating mode, cool air 17 from the structure 12 is fed into the exchanger 14 where it meets hot fluid 19, and warm air is returned. In a cooling mode, warm air 17 from the structure 12 is fed into the exchanger 14 where it meets cool fluid 19, and cool air is returned.

The ground coupled heat exchanger 18 provides the heat exchange fluid 19 with contact to subterranean region, or subsurface 20. The subsurface 20 provides a stable, nearly-constant temperature with a very large heat capacity to either act as a heat source or a heat sink for transfer with fluid 19 travelling through the heat exchanger 18. As shown in FIG. 1, the heat exchanger 18 comprises a single looped path 22. Loop exchanger 18 may alternatively be comprised of more than one parallel loop paths 22 to fulfill the heat exchange capacity within the heat exchanger 18. One skilled in the art will appreciate that the number, location and specifications of loops 22 depend on the design cooling or heating load required from the heat exchange system 10.

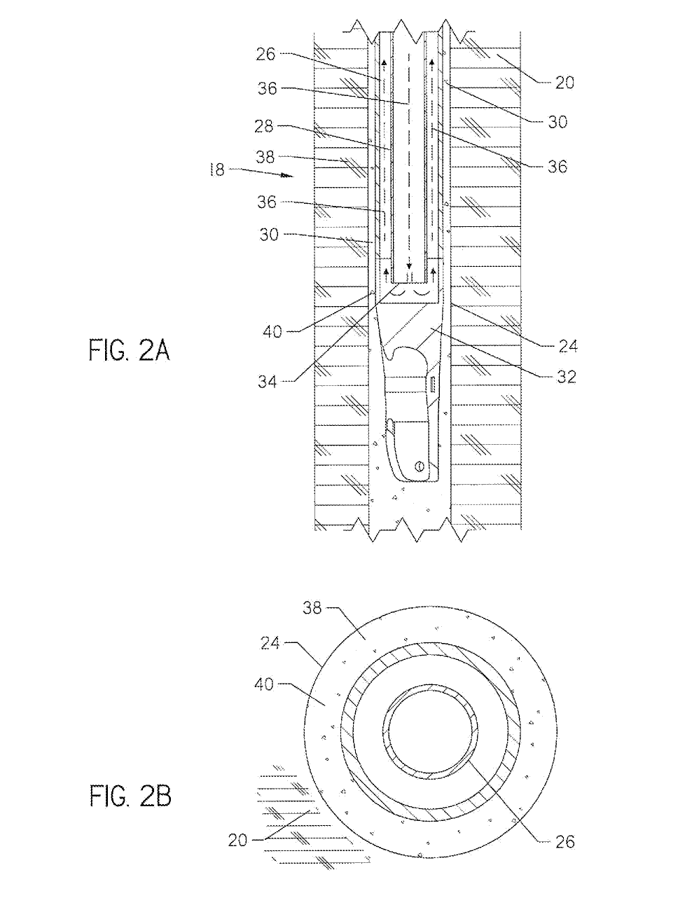

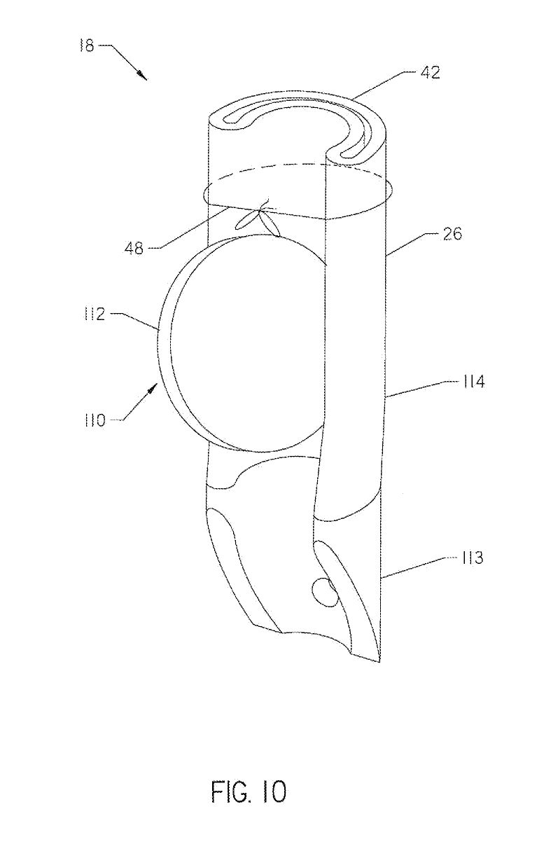

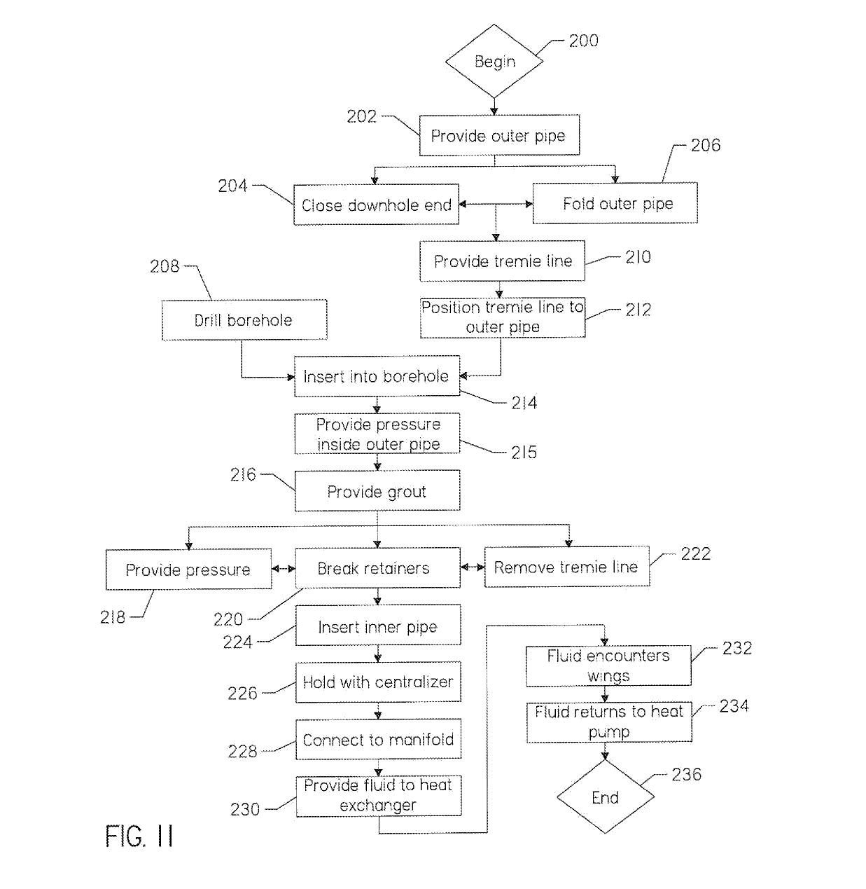

With reference now to FIGS. 2A and 2B, shown therein is a detailed sectional side and top view of a downhole portion of the ground coupled heat exchanger 18. The ground coupled heat exchanger 18 comprises a borehole 24, an outer pipe 26, an inner pipe 28, and a grouted region 30. The borehole 24 is drilled substantially vertically into the subsurface 20 by any known conventional means, leaving an open hole. One skilled in the art will appreciate that the borehole 24 may be drilled at any angle to the vertical or follow a curvilinear path. Further, the borehole 24 may comprise sections having different diameters, such as an upper borehole with a larger diameter than a lower borehole. The substantially cylindrical outer pipe 26 has a closed downhole end 32. Upon installation into the borehole, the outer pipe 26 is preferably folded as will be described with more particularity in FIG. 10. After installation, as will be described in more detail below, outer pipe 26 is preferably expanded to a mostly circular shape.

When installed and operating, it is advantageous for pipe 26 to be mostly round in shape with an effective diameter of the outer pipe 26 to be as close to the diameter of the borehole 24 as possible to allow for efficient heat transfer between fluid within the ground coupled heat exchanger 18 and the subsurface 20. The inner pipe 28 is located within the outer pipe 26. Preferably, the inner pipe comprises an open end 34 proximate the closed downhole end 32 of the outer pipe 26 to allow easy movement of fluid through open end 34. As designated by fluid path 36, fluid enters the ground coupled heat exchanger 18 through the inner pipe 28, travels downhole and exits through the open end 34 of the inner pipe, enters the outer pipe 26 proximate the closed downhole end 32, and travels uphole through the outer pipe. Alternatively, the direction of flow within ground coupled heat exchanger 18 may be reversed such that fluid flows downhole through outer pipe 26, enters the inner pipe 28 through the open end 34 and flows uphole through the inner pipe 28. One skilled in the art will appreciate that reverse flow direction within the ground source heat exchanger 18 may be advantageous for certain conditions.

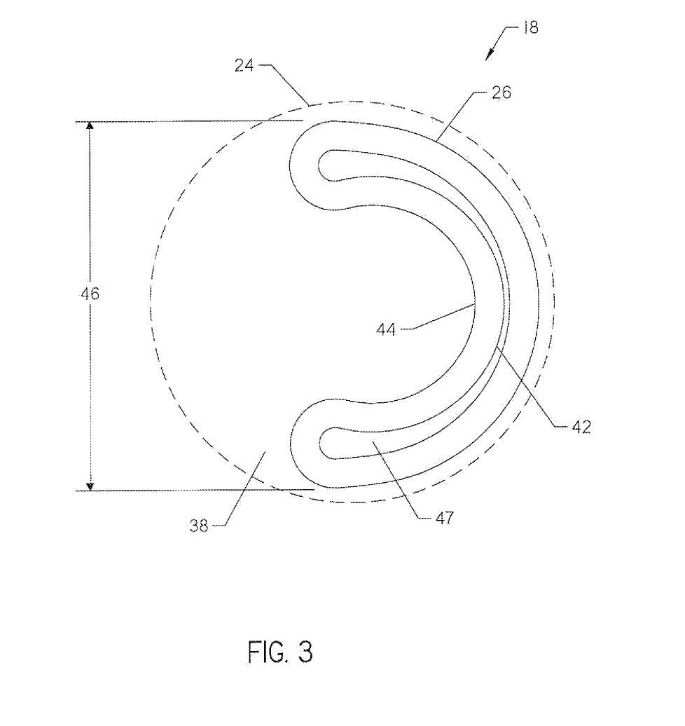

The grouted region 30 comprises an annulus 38 between the borehole 24 and the outer pipe 26. The grouted region 30 is filled with a grout material 40. The grout material 40 is designed for efficient heat transfer between the outer pipe 26 of the ground coupled heat exchanger 18 and the subsurface 20. One skilled in the art will appreciate that air is a poor conductor of heat, necessitating the use of the grout material 40 to substantially till the annulus 38. However, grout material 40 is expensive and may be lower in thermal conductivity than the surrounding subsurface 20, resulting in a reduced efficiency of the heat exchanger 18. Therefore, as shown in FIGS. 3-8, the ground coupled heat exchanger 18 is designed to minimize the volume of the grouted region 30 and thus the amount of grout material 40 required.

Turning now to FIG. 3, the ground coupled heat exchanger 18 is shown in cross-section during installation within the borehole 24. As shown, the outer pipe 26 comprises to a folded cross-section 42. In one embodiment, the folded cross-section 42 is formed by applying a force at wall portion 44 of a conventional circular tube or pipe. As a result, the folded cross-section 42 has an effective diameter 46 that is substantially smaller than the original diameter of the outer pipe 26 when unfolded. Preferably the outer pipe 26 may be folded outside of the borehole 24, inserted into the borehole, and then expanded to better fill the borehole 24 and is minimize the area of the annulus 38. The outer pipe 26 may be expanded by applying a pressure to an internal passage 47 of the outer pipe using a manifold with a pressure inlet (not shown) or other similar means.

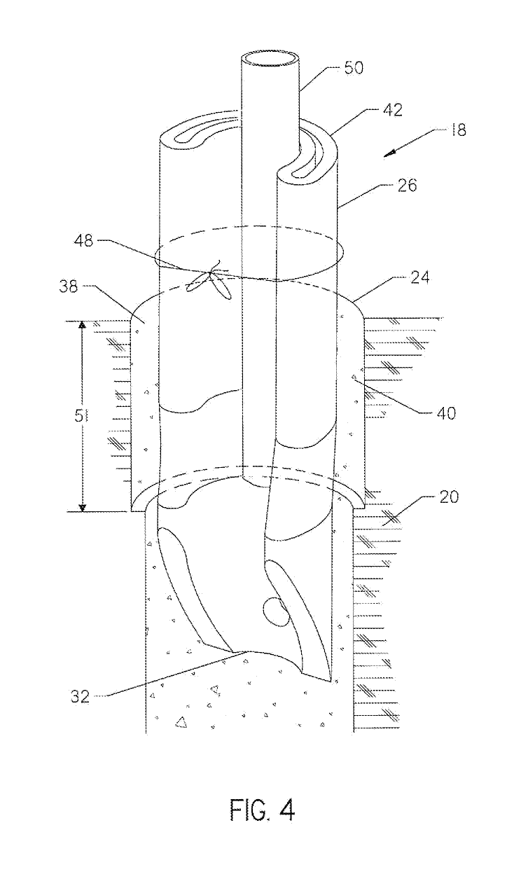

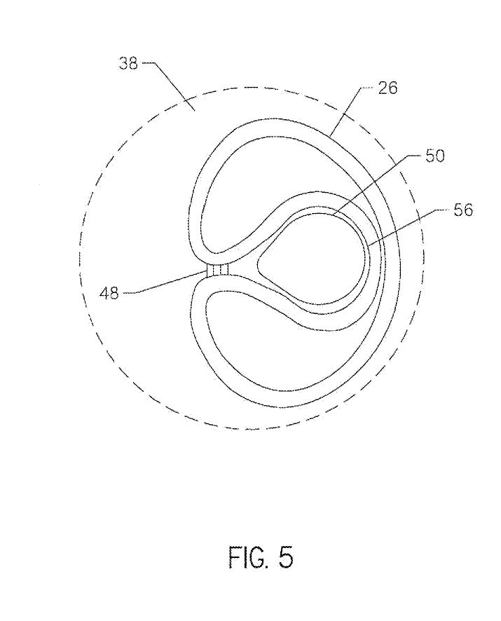

With reference now to FIG. 4, shown therein is a section of folded outer pipe 26 of the ground coupled heat exchanger 18. Those skilled in the art realize that the typical length of folded pipe 26 may be several hundred feet in length, though any length of folded pipe would fit within the scope of the ideas contained herein. The outer pipe 26 comprises the closed downhole end 32. The outer pipe 26 is shown inserted into the initial borehole 24 with a retainer 48 and a tremie line 50. As shown, the retainer 48 is a line tied around the outer pipe 26 to retain the outer pipe with a folded cross-section 42. Those skilled in the art may appreciate that retainers 48 could consist of plastic ties, tape, strap or other devices with sufficient strength to maintain the folded cross-section shape 42. Alternatively, as shown in FIG. 5, the retainer 48 may comprise bonding located along the outer pipe 26 forming a folded annulus 56. Those skilled in the art appreciate that bonding is able to maintain the folded configuration without external retainers and may consist of adhesives, heat fusion or a formed cross-section. The folded cross section may be maintained by forming the pipe in the folded cross-section shape with heat or other methods such that the folded shape is fixed within the memory of pipe 26 without external devices.

With reference again to FIG. 4, the tremie line 50 is adapted to provide grout material 40 to the annulus 38. After the outer pipe 26 is installed in the initial borehole 24, grout material 40 is pumped into the tremie line 50 and into a downhole end of the borehole. Pressure may also be provided inside the outer pipe 26 at the same time, causing the outer pipe 26 to begin unfolding. The pressure within the outer pipe causes the retainer 48 to break. Grout material 40 is pumped through tremie line 50 to collect in the annulus 38. In FIG. 4, pressure will cause the retainer 48 to break as the outer pipe 26 unfolds. In FIG. 5, pressure inside the outer pipe and within the folded annulus 56 will cause grout to break through the retainer bonding 48.

Continuing with FIG. 4, as grout material 40 fills the annulus 38, the tremie line 50 is slowly retracted, allowing the outer pipe 26 to more fully unfold below a downhole end of the tremie line. As the outer pipe 26 unfolds and increases in cross-section area, grout material 40 would begin to be pushed upwards as the annulus 38 decreases in area. It may be advantageous to modulate the pressure placed inside the outer pipe. For example, pressure may be set at a high level initially to unfold the outer pipe 26 below the tremie line 50. Pressure may then be lowered to a moderate level to retract the tremie line 50 a short distance along pipe 26 from the annulus 38. Once retracted, pressure may be increased again to fully unfold the outer pipe 26 and urge grout material 40 upward. If sections of the outer pipe 26 do not fully unfold, grout material will fill the annulus 38 near such sections to minimize the effect on performance of the ground coupled heat exchanger 18. Pressure would then be maintained within the outer pipe 26 until the grout material 40 is set within the annulus 38. Heat may also be used in conjunction with pressure to urge the unfolding of the outer pipe 26.

One skilled in the art will appreciate that unfolding the outer pipe 26 from the folded cross-section 42 while within the borehole 24 will minimize the volume of grout material 40 required to fully till the annulus 38. Reducing the thickness of the grouted region 30 (FIG. 2) will enhance the heat exchanged between the subsurface 20 and the ground coupled heat exchanger 18. Further, it may only be necessary to fill an upper portion 51 of the borehole 24 to effect the desired heat exchange. In some situations where grout 40 is not required by regulation, the outer pipe 26 may be used fully fill the borehole 24, resulting in no grout required in the annulus 38.

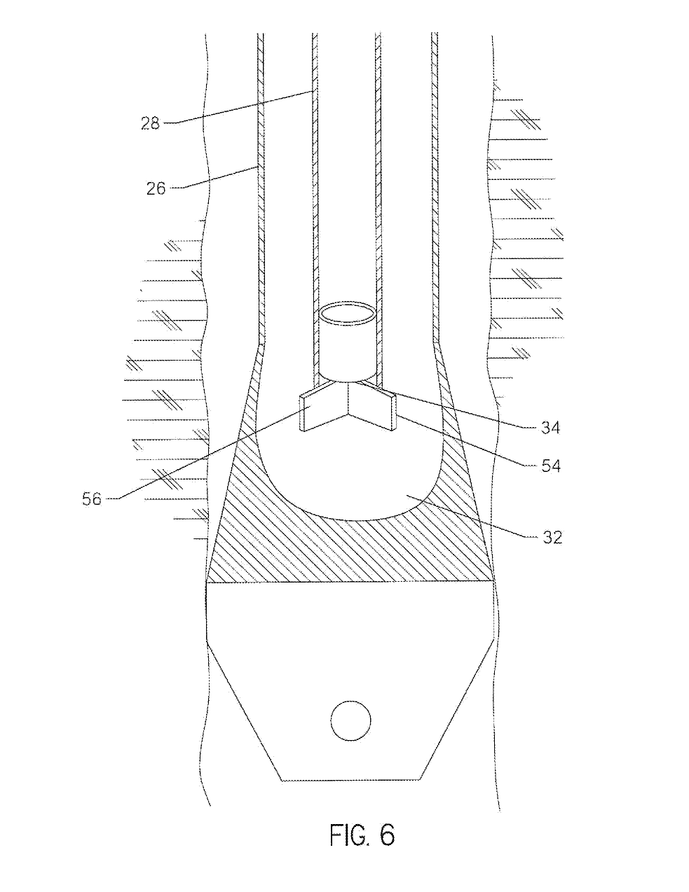

With reference now to FIG. 6, the closed downhole end 32 of the outer pipe 26 is shown with the open end 34 of the inner pipe 28 installed therein. As shown, the inner pipe 28 comprises a spacer 54 connected to the open end 34. The spacer 54 keeps the open end 34 spaced away from the closed end 32 of the outer pipe 26. Further, the spacer 54 comprises projections 56 to keep flow of fluid from being blocked by contacting the outer pipe. Other embodiments may be utilized to prevent the obstruction of flow without the use of the spacer 54, is such as cutting off the inner pipe length to a prescribed distance shorter than length of outer pipe 26, holes (not shown) near the open end 34, notches cut into the inner pipe 28, or a slanted cut at the open end of the inner pipe.

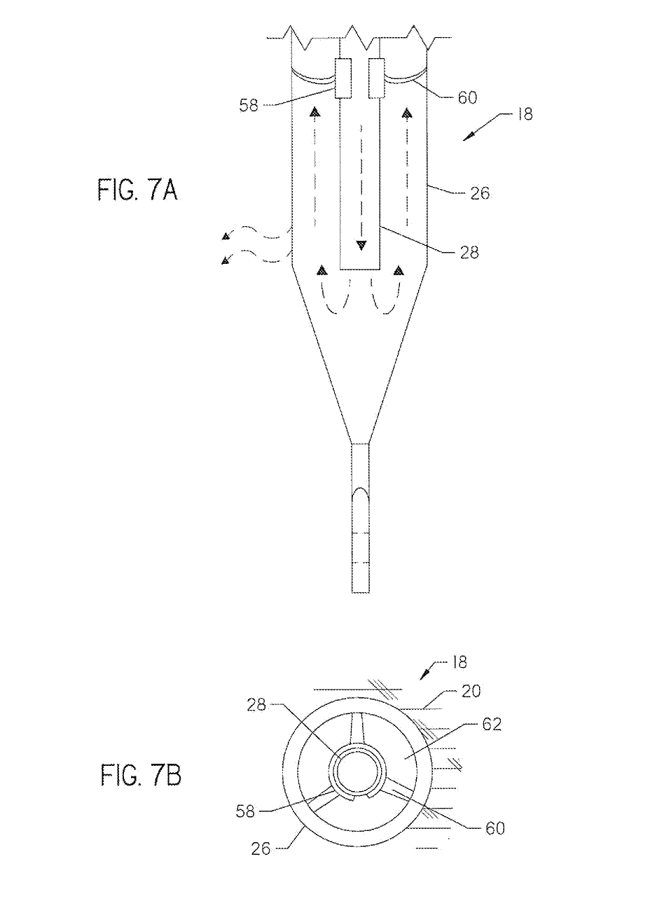

With reference now to FIG. 7A, the ground coupled heat exchanger 18 comprises a centralizer 58. The centralizer 58 is attached to the inner pipe 28 and generally coaxially aligns the inner pipe 28 within the outer pipe 26. Though one centralizer 58 is shown in FIG. 7A, one or more centralizers may be utilized. Centralizers 58 may be spaced along the inner pipe 28 and may be snapped, glued or attached to the inner pipe or may be held in place by friction. With reference to FIG. 7B, the centralizer 58 comprises one or more wings 60. The wings 60 extend from the inner pipe 28 to the outer pipe 26. The wings 60 define gaps 62 between the wings to allow fluid to flow within the outer pipe 26. Wings 60 may deflect to allow for installation of the inner pipe 28 into the outer pipe 26 with the centralizer 58 pre-attached. The wings 60 further cause flow within the gaps 62 to become more turbulent, enhancing heat transfer between the heat exchanger 18 and the subsurface 20.

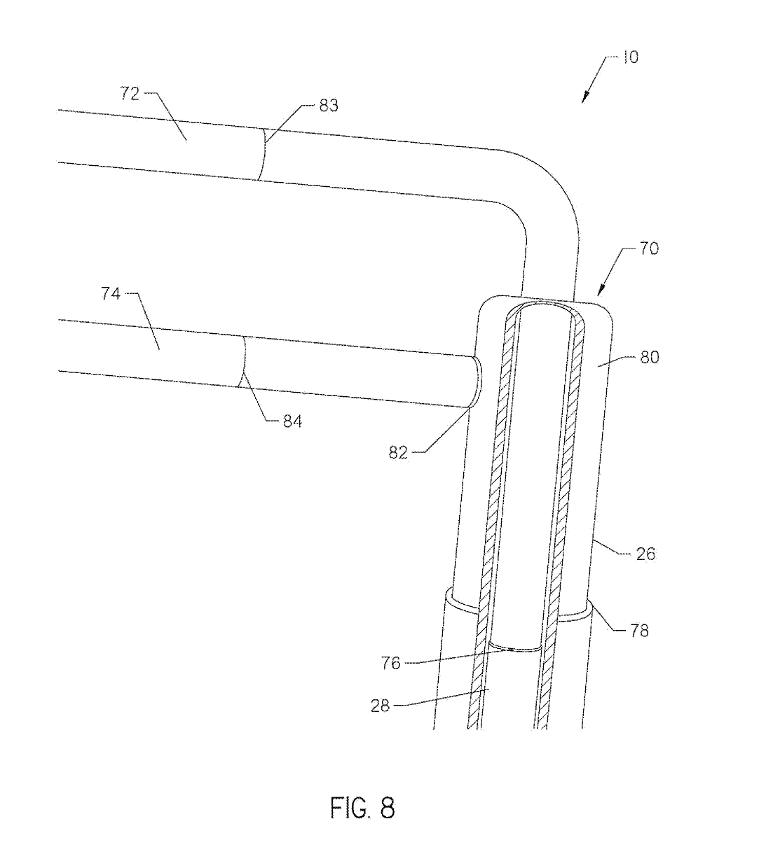

With reference now to FIG. 8, the heat exchange system 10 comprises a manifold 70 for attaching the ground coupled heat exchanger 18 (FIG. 2) to the air to fluid heat exchanger 14 within the heat pump 16 (FIG. 1). Attachments to the manifold 70 typically comprise a supply pipe 72, a return pipe 74, an inner joint 76 and an outer joint 78. The supply pipe 72 carries fluid from the air to fluid exchanger 14 into the inner pipe 28 of the ground coupled heat exchanger and connects to the manifold at a supply pipe joint 83. The inner pipe 28 and supply pipe 72 couple at the inner joint 76; those skilled in the art appreciate that one or more inner pipe joints 76 could be located at various positions along the inner pipe pathway to attached manifold 70 to facilitate inner pipe flow. The inner joint 76 may be created by joining inner pipe 28 and supply pipe 72 in a manner known in the industry. The return pipe 74 carries fluid from the outer pipe 26 to the air to fluid exchanger 14 and connects to the manifold 70 at a return pipe joint 84. The outer joint 78 comprises an end cap 80. The end cap 80 may be fused to the outer pipe 26 and provides a connection to the return pipe 74 at joint 84. An entry point 82 provides a pathway for fluid from the outer pipe 26 to flow into the return pipe 74. The connection of joint 78 may be created by a split heater element (not shown) or other means. Those skilled in the art appreciate that manifold 70 and its connections between outer pipe 26 and return pipe 74, and inner pipe 28 and supply pipe 72 could be constructed in numerous configurations to facilitate attachment of manifold 70.

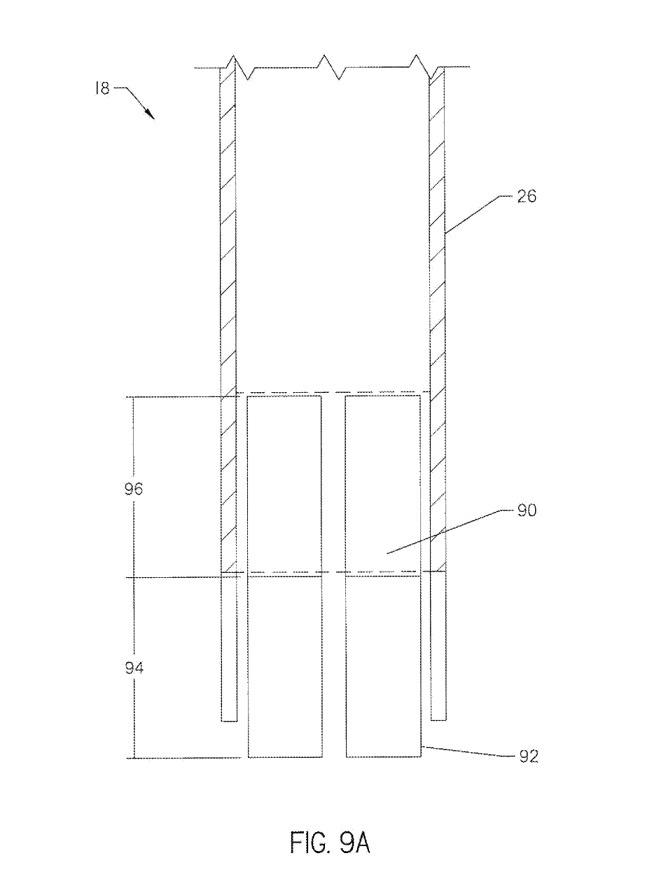

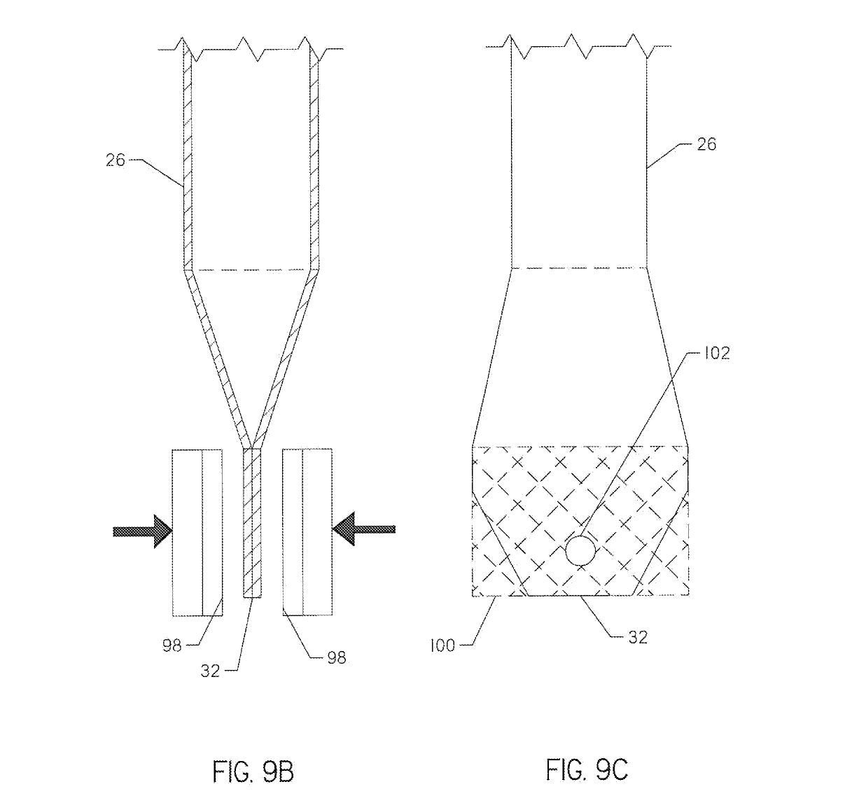

With reference to FIG. 9A, a fusing apparatus 90 for use with the outer pipe 26 of the ground coupled heat exchanger 18 is shown. The outer pipe 26 may be made from high density polyethylene (HDPE), though other materials with sufficient flexibility and strength might also be used. The fusing apparatus 90 comprises heater elements 92. Heater elements 92 may be designed to match the inside geometry of the outer pipe 26. Heater elements 92 are urged radially outward to contact an inner side of the outer pipe 26. Heater elements 92 are then held in place for a prescribed time period. Alternatively heater elements 92 may comprise non-contact radiant heating elements or other types of heating methods. The heater elements 92 may differ in temperature to create a fusion section 94 and a transition section 96 of the outer pipe 26.

With reference now to FIG. 9B, after the heater elements 92 are removed, fusion plates 98 are quickly moved towards the outer pipe 26, flattening and closing the downhole end 32. Fusion plates 98 may comprise semi-circular contact areas to produce a semi-circular closed downhole end 32. A semi-circular shape better facilitates folding the pipe as described with reference to FIG. 10, but other geometrical shapes may be used.

With reference to FIG. 9C, corners 100 may be removed to reduce the chance that the closed downhole end 32 will hang up on a ledge or other discontinuity during insertion into the borehole 24 (FIG. 4). The closed downhole end 32 may comprise a hole 102. A small weight (not shown) may be attached to the hole 102 to aid in pulling the outer pipe 26 into the borehole 24.

Alternatively, one skilled in the art can contemplate that fusing the closed downhole end 32 of the outer pipe 26 may take place after folding the outer pipe as described below.

With reference to FIG. 10, a folding apparatus 110 for use with the outer pipe 26 of the ground source heat exchanger 18 is shown. The folding apparatus 110 comprises one or more rollers 112. The outer pipe 26 is urged through the rollers 112, creating the folded cross-section 42. Alternatively, the rollers 112 may be urged along the outer pipe 26. The rollers 112 may be arranged to progressively bend the outer pipe 26 from its round shape to the folded cross-section. The rollers 112 may fold the outer pipe 26 with or without heat. For some materials, folding without heat may allow the outer pipe 26 to return to its original shape with less pressure. After folding is complete, the retainer 48 is added to retain the outer pipe with the folded cross-section 42 until unfolding is desired.

With continued reference to FIG. 10, a terminal end of the ground coupled heat exchanger 18 comprises a formed and closed end cap 113 that may be utilized alternatively rather than the fusing apparatus 90 of FIGS. 9A-9C. The end cap 113 is formed from HDPE or other similar material as the outer pipe 26. Preferably the end cap 113 is attached to pipe 26 at a connection joint 114 by fusion or other common attachment methods well understood in the industry/ Preferably the end cap 113 is shaped to better facilitate folding of the outer pipe 26 and easy insertion into the borehole 24. Alternatively, those skilled in the art appreciate that common dome shaped caps and other closed end caps could be used. Typically attachment between cap 113 and the outer pipe 26 would be accomplished by heat fusion before folding of the outer pipe 26. Though those skilled in the art may contemplate fusion or other methods of attachment after folding of the outer pipe 26.

With reference now to FIG. 11, in practice, the ground coupled heat exchanger 18 of FIGS. 1-10 is installed by a method that starts at 200. The outer pipe 26 is provided at 202. A downhole end 32 of the outer pipe 26 is closed by fusion or other method at 204. The outer pipe 26 is folded lengthwise at 206. In a preferred embodiment the outer pipe 26 is folded to a U-shaped cross-section where the cross sectional effective diameter 46 is smaller than the original round diameter. The borehole 24 is drilled at 208. One skilled in the art should understand that steps 204, 206 and 208 may happen in any order. The tremie line 50 is provided with the outer pipe 26 at 210. The tremie line 50 may be attached to the outer pipe 26 by the retainer 48 at 212. This retainer 48 may be the line as in FIG. 4 or may comprise the bonding 54 of the folded annulus 56 as described with reference to FIG. 5.

With continuing reference to FIG. 11, the folded outer pipe 26 and the tremie line 50 are inserted into the borehole 24 at 214. In step 215, a manifold is used to provide a pathway for the addition of pressure inside folded outer pipe 26. Grout is provided to the borehole 24 at 216 through the tremie line 50. At 218 a pressure is provided within the outer pipe 26 causing grout material 40 to fill an annulus between the outer pipe 26 and the borehole 24 as the outer pipe 26 is expanded at 220. The pressure provided at step 218 causes the retainer 48 to break. The tremie line 50 is removed from the borehole 24 at 222. In one embodiment of the invention, steps 218, 220 and 222 take place substantially simultaneously, though one skilled in the art should understand that they may take place as a series of sequential steps in any order as long as grout is applied where needed, pipe 26 is mostly expanded and the tremie line 50 is removed.

The inner pipe 28 is provided within the expanded outer pipe 26 at 224. The inner pipe 28 is held generally coaxially by the centralizers 58 described in FIG. 8 at 226. The inner pipe 28 and outer pipe 26 are connected to the manifold 70 for connection to a heat pump 16 at 228. Heat exchange fluid is then provided by the heat pump system 16 to the ground heat exchanger 18 at 230, becomes more turbulent when encountering wings 60 of the centralizers 58 at 232 and returns to the heat pump 16 at 234. During steps 230 through 234, heat is being transferred between heat exchange fluid 19 and subsurface region 20. In a heat exchange system 10 for heating a dwelling, cold heat exchange fluid is heated in the ground coupled heat exchanger 18 by heat from the subsurface 20. In a heat exchange system 10 for cooling a dwelling, hot fluid is cooled in the ground coupled heat exchanger 18 by heat being transferred into the subsurface 20. The method ends at 236.

Various modifications can be made in the design and operation of the present invention without departing from the spirit thereof. Thus, while the principal preferred construction and modes of operation of the invention have been explained in what is now considered to represent its best embodiments, which have been illustrated and described, it should be understood that the invention may be practiced otherwise than as specifically illustrated and described.

What is claimed is:

1. A method for installation of a ground coupled heat exchange system for use in a ground source heat pump system comprising:
inserting a folded outer pipe into a borehole; and
expanding the folded outer pipe within the borehole.

2. The method of claim 1 wherein the outer pipe comprises a terminal end, the method further comprising sealing the terminal end of the outer pipe before inserting the outer pipe into the borehole.

3. The method of claim 1 further comprising applying pressure within the folded outer pipe to expand the outer pipe within the borehole.

4. The method of claim 1 further comprising applying a grout to an annulus formed between the outer pipe and the borehole.

5. The method of claim 4 wherein the grout is applied to a portion of the borehole.

6. The method of claim 4 wherein the step of applying grout to the annulus between the outer pipe and the borehole occurs before expanding the outer pipe.

7. The method of claim 1 further comprising inserting an inner pipe into the outer pipe.

8. A method for installing a ground coupled heat exchange system comprising:
drilling a borehole;
folding a first pipe to form a U-shaped cross-section;
inserting the first pipe into the borehole;
supplying grout to an annulus between the borehole and the first pipe;
applying a pressure to unfold the first pipe; and
inserting a second pipe into the first pipe.

9. The method of claim 8 wherein the step of supplying grout is taken after applying a pressure to unfold the first pipe.

10. The method of claim 8 wherein the step of supplying grout is taken substantially simultaneously with the step of providing a pressure.

11. The method of claim 8 wherein the first pipe is folded to form an internal channel and wherein the first pipe comprises bonding to maintain the internal channel.

12. The method of claim 11 wherein the step of providing grout comprises:
inserting a tremie line into the internal channel;
sealing an upper end of the first pipe;
pumping grout into the first pipe through the tremie line such that the bonding is broken and grout enters the annulus;
applying a pressure within the first pipe to distribute grout within the annulus; and
removing the tremie line.

13. The method of claim 12 wherein the tremie line is inserted into the borehole with the first pipe when folded.

14. The method of claim 12 wherein the tremie line is held within the U-shaped cross-section of the first pipe by a retainer.

15. The method of claim 14 further comprising the step of breaking the retainer by applying the pressure within the first pipe.

16. The method of claim 8 further comprising providing heat to unfold the first pipe.

17. The method of claim 8 wherein the second pipe is arranged generally coaxially within the first pipe.

18. The method of claim 8 wherein the second pipe is held in a generally coaxial position within the first pipe by at least one centralizer.

19. The method of claim 8 further comprising attaching an upper end of the second pipe to a supply pipe and attaching an upper end of the first pipe to a return pipe.

20. The method of claim 8 where a terminal end of the first pipe is sealed prior to insertion in the borehole.

21. The method of claim 8 wherein folding the first pipe occurs prior to insertion in the borehole.

22. The method of claim 21 wherein folding the first pipe comprises using one or more rollers without applying heat to the first pipe.

23. (canceled)

24. The method of claim 8 wherein the second pipe is inserted into the first pipe prior to inserting the first pipe into the borehole.

25. The method of claim 8 wherein a lower end of the second pipe comprises at least one exit pathway for fluid passage.

26-30. (canceled)

31. A ground coupled heat exchange apparatus comprising:
a foldable outer pipe for placement within a borehole;
an inner pipe located within the outer pipe; and
a material positioned in an annulus between the borehole and the outer pipe to secure the outer pipe within the borehole.

32. The apparatus of claim 31 further comprising a supply pipe connected to an upper end of the inner pipe and a return pipe connected to an upper end of the outer pipe.

33. The apparatus of claim 31 further comprising a supply pipe connected to an upper end of the outer pipe and a return pipe connected to an upper end of the inner pipe.

34. The apparatus of claim 31 further comprising heat exchange fluid travelling through the supply pipe, into the heat exchange apparatus, through the outer pipe, and into the return pipe.

35. The apparatus of claim 31 wherein the heat exchange fluid in the supply pipe has a different temperature than the ground proximate the borehole.

36. The apparatus of claim 31 wherein the foldable outer pipe comprises a sealed terminal end.

37. A method for securing a ground-source heat exchanger comprising a foldable pipe within a vertical borehole, the method comprising:
providing the foldable pipe within the borehole;
placing a tremie line proximate the foldable pipe;
pumping a material into the vertical borehole through the tremie line; and
applying a pressure inside the foldable pipe to unfold the foldable pipe such that the material is distributed about the foldable pipe.

38. The method of claim 37 further comprising the step of retaining the foldable pipe using a retainer.

39. The method of claim 38 wherein the steps of pumping the material into the borehole and applying a pressure inside the folded pipe cause the retainer to break.

40. The method of claim 37 wherein the steps of pumping the material and applying a pressure occur substantially simultaneously.

41. The method of claim 37 further comprising the step of removing the tremie line as the pressure causes the foldable pipe to unfold.

42. A ground coupled heat exchanger for placement within a borehole comprising:
a folded, expandable outer pipe with a reduced effective diameter comprising an open first end and a sealed second end;
wherein the outer pipe is capable of having a larger effective diameter;
an inner pipe capable of being inserted coaxially into the open first end; and
a manifold attachable to the open first end of the outer pipe and the inner pipe.

43. The apparatus of claim 42 wherein the outer pipe is expandable by providing pressure within the outer pipe.

44. The apparatus of claim 43 wherein the outer pipe is expandable by heat.

45. The apparatus of claim 42 wherein the outer pipe is folded before insertion into a borehole.

46. The apparatus of claim 45 wherein the outer pipe is unfolded after insertion into the borehole.

47. The apparatus of claim 42 wherein a cross section of the folded outer pipe is U-shaped.

48. The apparatus of claim 42 further comprising a tremie line adapted to be positioned proximate the outer pipe.

49. The apparatus of claim 48 further comprising a plurality of retainers to hold the tremie line proximate the folded outer pipe.

50. The apparatus of claim 49 wherein the plurality of retainers comprises bonding.

51. The apparatus of claim 42 further comprising a centralizer located about the inner pipe to maintain the inner pipe in a generally coaxial relationship with the outer pipe.

52. The apparatus of claim 42 wherein the inner pipe is positionable within the outer pipe when the outer pipe is folded.
